(19) United States
(12) Patent Application Publication
(10) Pub. No.: US 2006/0121843 A1
(43) Pub. Date: Jun. 8, 2006

(54) Steering wheel ventilation system and method

(75) Inventor: Barry Koval, Phoenix, AZ (US)

Correspondence Address: FOLEY AND LARDNER LLP;SUITE 500, 3000 K STREET NW, WASHINGTON, DC, 20007, US

(73) Assignee: NISSAN TECHNICAL CENTER NORTH AMERICA, INC.

(21) Appl. No.: 11/005,296

(22) Filed: Dec. 7, 2004

(51) Int. Cl. B60H 1/34

(52) U.S. Cl. 454/152

(57) ABSTRACT

A vehicle steering wheel is provided with an air duct in fluid communication with the vehicle ventilation system to permit air from the ventilation system to be directed toward the driver of the vehicle through the wheel mounted air duct. The air duct is connected to the vehicle ventilation system by means of a air channel along the steering wheel drive shaft.

### BACKGROUND OF THE INVENTION

The present invention relates generally to the field of environmental systems for vehicles. In particular, the invention provides systems and methods which provide air to a driver.

In conventional systems, ventilation exhaust for a vehicle is directed through fixed positions such as the instrument panel, center console and doors. Although this arrangement may be suitable for passengers in, for example, the front seat of a vehicle, it may be less than ideal for the driver of the vehicle. The flow of the air to the driver may be obstructed, for example, by the steering wheel. Further, adjustment of the flow may require awkward movement by the driver to access an adjustable vent.

### SUMMARY OF THE INVENTION

The disclosed embodiments of the present invention provide systems and methods which provide air to the driver of the vehicle in a convenient and efficient manner. Embodiments of the invention may also allow for convenient adjustment of the air flow by the driver.

One aspect of the invention relates to a steering wheel arrangement for a vehicle. The steering wheel arrangement includes a steering column extending from a vehicle body to a steering wheel; an air passage formed along at least a portion of an external surface of the steering column, the air passage being adapted to convey air from a vehicle ventilation system; and at least one air outlet in fluid communication with the air passage and positioned at the steering wheel for venting air from the vehicle ventilation system.

In a particular embodiment, the air passage is formed by the external surface of the steering column and an internal surface of an outer column positioned along the external surface of the steering column. The outer column may be positioned substantially concentrically around the steering column and may be formed of a light-duty plastic. In one embodiment, the steering wheel arrangement also includes a slip ring positioned at an intersection of the steering wheel and the outer column, the slip ring being adapted to maintain a seal between the steering wheel and the outer column.

In one embodiment, the air outlet includes a vent positioned on a front face of a hub region of the steering wheel. The vent may be an adjustable vent adapted to allow a user to adjust the direction of air flow out of the vent.

In a particular embodiment, the air outlet includes a vent positioned to direct air flow toward a user positioned in front of the steering wheel.

In a particular embodiment, the vehicle ventilation system includes a heating, ventilation and air conditioning (HVAC) system.

In a particular embodiment, the steering wheel arrangement also includes a vehicle environment control system adapted to allow a user to select or deselect venting of air through the air outlet. The vehicle environment control system may include a selector adapted to allow the user to select from a plurality of settings, at, least one of the settings corresponding to venting of air through the air outlet.

In another aspect, the invention includes a steering wheel arrangement for a vehicle. The steering wheel arrangement includes a steering column extending from a vehicle body to a steering wheel and including an inner column housing a steering shaft therein; an outer column positioned substantially concentrically around said inner column and forming an annular passage between the inner column and the outer column, the annular passage being adapted to convey air from a vehicle ventilation system; and at least one outlet on the steering wheel, said at least one outlet being in fluid communication with the annular passage for venting the air from the vehicle ventilation system.

Another aspect of the invention includes a steering wheel arrangement for a vehicle. The steering wheel arrangement includes means for conveying air from a vehicle ventilation system, along a steering column of a vehicle, the steering column extending from a vehicle body to a steering wheel; and means, mounted on the steering wheel, for venting the air from the vehicle ventilation system.

Another aspect of the invention includes a method of providing air to a driver of a vehicle. The method includes providing a heating/air conditioning (HVAC) system for the vehicle; providing an air flow path from the HVAC system along a steering column of the vehicle and to an outlet located at a steering wheel of the vehicle; forcing air through the air flow path; and exhausting air from the air flow path through the outlet.

### BRIEF DESCRIPTION OF THE DRAWINGS

Exemplary embodiments will hereafter be described with reference to the accompanying drawings, in which:

FIG. 1 is a perspective view of an embodiment of a steering wheel arrangement according to the present invention;

FIGS. 2A-2C are cross-sectional views taken along II-II of FIG. 1 illustrating embodiments of steering column arrangements;

FIG. 3 is a cross-sectional view taken along III-III of FIG. 2A illustrating an embodiment of the steering wheel arrangement; and

FIG. 4 illustrates an exemplary environment control system.

### DETAILED DESCRIPTION OF THE PREFERRED EMBODIMENTS

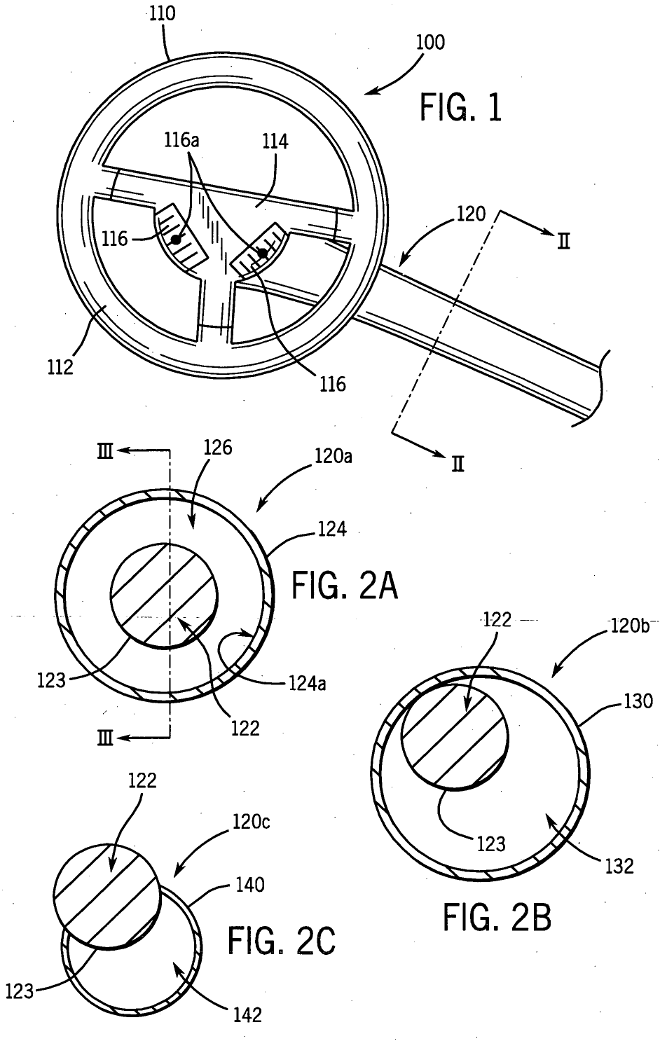

Referring to FIG. 1, a perspective view of an embodiment of a steering wheel arrangement is illustrated. The steering wheel arrangement 100 includes a steering wheel 110 mounted at one end of a steering column 120 extending from the vehicle body (not shown), where the steering column 120 may be adapted to control the steering of the vehicle. The steering wheel 110 illustrated in FIG. 1 includes a hub-and-spoke configuration, including a hub 114 connected to a rim 112 through a plurality of spokes. Although the illustrated embodiment includes a steering wheel having a hub-and-spoke configuration, numerous other configurations are contemplated within the scope of the invention.

The hub 114 of the steering wheel 110 is provided with one or more air outlets 116. The air outlets 116 are adapted to vent air from a heating, ventilation and air conditioning (HVAC) system of the vehicle. In a particular embodiment, the air outlets 116 are adjustable vents which allow a user to vary the direction and magnitude of the air flow by means of, for example, lever 116a.

Air is directed to the air outlets 116 from the HVAC system through the steering column 120. In this regard, FIGS. 2A-2C illustrate cross-sectional views of certain embodiments of steering columns 120a-c respectively in accordance with the invention. FIG. 2A illustrates a steering column 120a having an inner column 122 including a steering shaft. The inner column 122 has an outer surface 123 that has a substantially circular cross-section. An outer column 124 is positioned concentrically around the inner column 122. The outer column 124 may be formed of any of a variety of materials. Since the outer column 124 is not required to mechanically support any substantial weight, it can be formed of a light-duty plastic sufficient to direct air.

The outer surface 123 of the inner column 122 and an inner surface 124a of the outer column 124 form an air passage 126 therebetween. Thus, in the embodiment illustrated in FIG. 2A, an air passage 126 having an annular configuration is provided for directing air from the HVAC system to the air outlets on the steering wheel.

In other embodiments, such as that illustrated in FIG. 2B, a steering column 120b includes an outer column 130 positioned around the inner column 122 in an non-concentric manner. Thus, an air passage 132 having a irregular shape and adapted to direct air around substantially the entire outer surface 123 of the inner column 122 may be formed.

FIG. 2C illustrates yet another embodiment of a steering column. The illustrated steering column 120c includes the inner column 122 and an outer column 140 formed along a portion of the inner column. Thus, an air passage 142 is formed to allow air to be directed along a portion of the outer surface 123 of the inner column 122. The size of the outer column 140 and, therefore, the size of the air passage 142 may be selected according to desired air flow and HVAC system requirements.

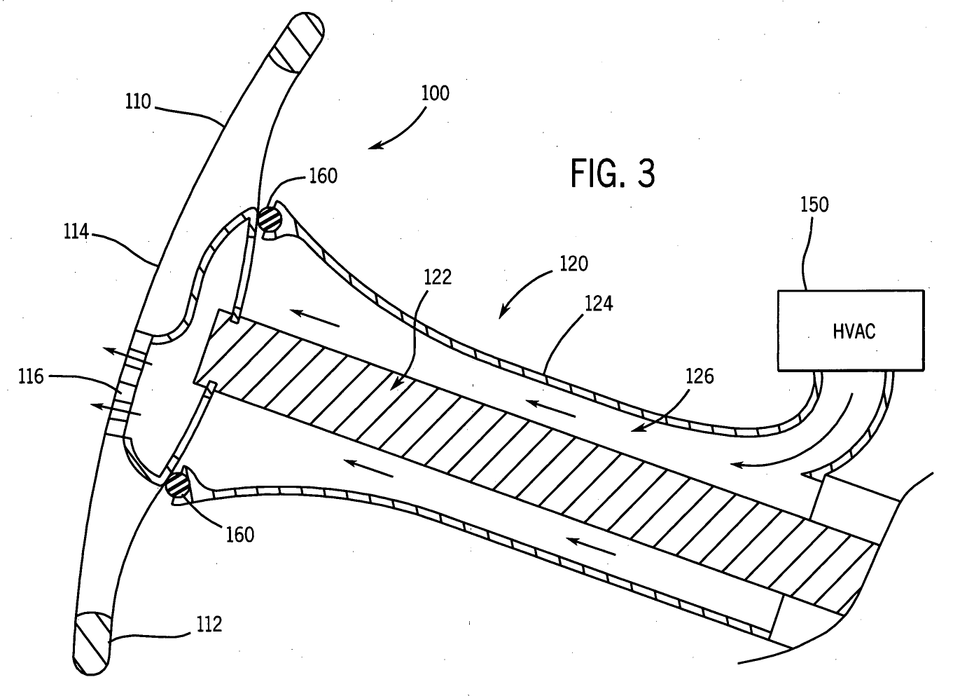

FIG. 3 illustrates, as an example, a cross-sectional view of the steering wheel arrangement of FIG. 1 having the steering column of FIG. 2A. FIG. 3 illustrates the flow of air from the HVAC system 150 of the vehicle through the annular air passage 126 formed between the inner column 122 and the outer column 124 of the steering column 120. Air flowing through the air passage 126 is directed to the hub 114 of the steering wheel 110 and through the air outlet 116. In this regard, one or more passages may be formed within the hub 114 of the steering wheel 110.

Of course, the steering wheel 110, as well as the inner column 122 including a steering shaft, are allowed to rotate about a longitudinal axis. For stability and aesthetic purposes, the outer column 124 may not rotate. Thus, in order to prevent leakage or discharge of the airflow, a slip ring 160 may be provided at the junction of the outer column 124 and the steering wheel 110. The slip ring may be formed of a rubber or elastic material adapted to maintain a seal between the outer column 124 and the steering wheel 110.

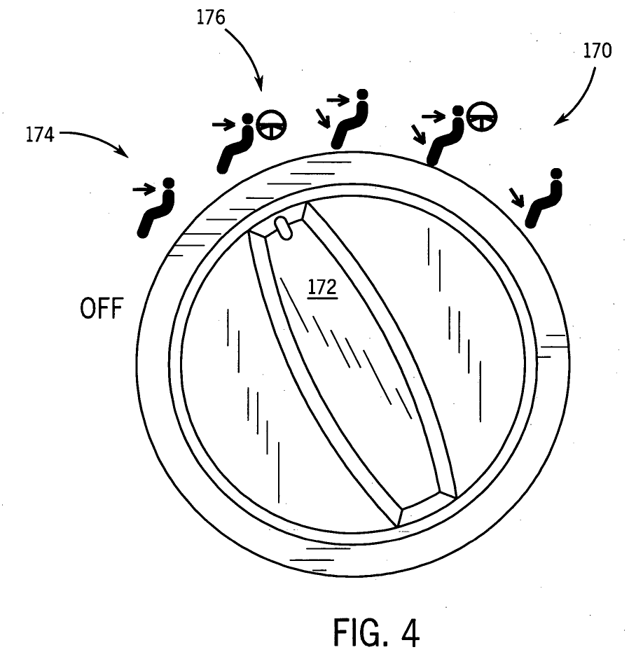

The flow of air through the air outlet or outlets 116 on the steering wheel 110 may be controlled by the user through an environmental control system. An exemplary environment control system 170 is illustrated in FIG. 4. The control system 170 includes a selector dial 172 adapted to be turned by a user. The selector dial 172 illustrated in FIG. 4 includes an indicator of the present setting 172a. The selector dial 172 may be turned to select one of a plurality of settings 174. Each setting indicates where the air from the HVAC system should be directed. For example, the selector dial may be turned to the “OFF” position to turn off the HVAC system. If the user desires to select venting of the air through the steering wheel, the selector dial can be turned to the second setting 176, which causes air to be directed to one or more upper outlets on an instrument panel, as well as the steering wheel. In this regard, the second setting 176 is provided with a symbol indicative of the steering wheel. When this setting is selected, air is flowed from the HVAC system, through the steering column, and vented through the air outlets 116 on the steering wheel, providing air to the driver. When a user desires to deselect the venting of air through the steering wheel, the selector dial may be turned to the first position, which indicates flow of air only to the upper air outlets, but not to the steering wheel. Similarly, flow of air to various combinations of air outlets may be selected.

Thus, the embodiments described above provide convenient and efficient systems and methods for providing ventilation to the driver of a vehicle.

In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

While the exemplary embodiments illustrated in the Figures and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims

What is claimed is:

1. A steering wheel arrangement for a vehicle, comprising:
a steering column extending from a vehicle body to a steering wheel;
an air passage formed along at least a portion of an external surface of the steering column, the air passage being adapted to convey air from a vehicle ventilation system; and
at least one air outlet in fluid communication with said air passage and positioned at the steering wheel for venting air from the vehicle ventilation system.

2. The steering wheel arrangement of claim 1, wherein the air passage is formed by the external surface of the steering column and an internal surface of an outer column positioned along the external surface of the steering column.

3. The steering wheel arrangement of claim 2, wherein the outer column is positioned substantially concentrically around the steering column.

4. The steering wheel arrangement of claim 2, wherein the outer column is formed of a light-duty plastic.

5. The steering wheel arrangement of claim 2, further comprising:
a slip ring positioned at an intersection of the steering wheel and the outer column, said slip ring adapted to maintain a seal between the steering wheel and the outer column.

6. The steering wheel arrangement of claim 1, wherein the at least one air outlet includes a vent positioned on a front face of a hub region of the steering wheel.

7. The steering wheel arrangement of claim 6, wherein the vent is an adjustable vent adapted to allow a user to adjust the direction of air flow out of the vent.

8. The steering wheel arrangement of claim 1, wherein the at least one air outlet includes a vent positioned to direct air flow toward a user positioned in front of the steering wheel.

9. The steering wheel arrangement of claim 1, wherein the vehicle ventilation system includes a heating, ventilation and air conditioning (HVAC) system.

10. The steering wheel arrangement of claim 1, further comprising:
a vehicle environment control system adapted to allow a user to select or deselect venting of air through the at least one air outlet.

11. The steering wheel arrangement of claim 10, wherein the vehicle environment control system includes a selector adapted to allow the user to select from a plurality of settings, at least one of the settings corresponding to venting of air through the at least one air outlet.

12. A steering wheel arrangement for a vehicle, comprising:
a steering column extending from a vehicle body to a steering wheel and including an inner column housing a steering shaft therein;
an outer column positioned substantially concentrically around said inner column and forming an annular passage between the inner column and the outer column, the annular passage being adapted to convey air from a vehicle ventilation system; and
at least one outlet on the steering wheel, said at least one outlet being in fluid communication with said annular passage for venting the air from the vehicle ventilation system.

13. A steering wheel arrangement for a vehicle, comprising:
means for conveying air from a vehicle ventilation system, along a steering column of a vehicle, the steering column extending from a vehicle body to a steering wheel; and
means, mounted on the steering wheel, for venting the air from the vehicle ventilation system.

14. A method of providing air to a driver of a vehicle comprising the steps of:
providing a heating/air conditioning (HVAC) system for said vehicle;
providing an air flow path from said HVAC system along a steering column of said vehicle and to an outlet located at a steering wheel of said vehicle;
forcing air through said air flow path; and
exhausting air from said air flow path through said outlet.
